(19) United States
(12) Patent Application Publication
(10) Pub. No.: US 2020/0042846 A1
(43) Pub. Date: Feb. 6, 2020

(54) IDENTIFICATION CODE

(71) Applicant: SHARP KABUSHIKI KAISHA, Sakai City (JP)

(72) Inventor: MASAHIRO TAKAHASHI, Sakai City (JP)

(21) Appl. No.: 16/529,758

(22) Filed: Aug. 1, 2019

Related U.S. Application Data
(60) Provisional application No. 62/713,892, filed on Aug. 2, 2018.

(51) Int. Cl. G06K 19/06

(52) U.S. Cl. CPC G06K 19/06037

(57) ABSTRACT

An identification code includes dot position groups adjacent two of which are located such that a circumscribed circle of the dot positions in one of the dot position groups on an inner side and as inscribed circle of the dot positions in another of the dot position groups on an outer side overlap each other. The dot positions in each of the dot position groups have different individual information pieces depending on the dot positions located relative to a line connecting the center mark with the reference mark. One of the dot positions in each of the dot position groups is selectively represented by one or more of the dots such that the individual information piece at the selected dot position represents information for the corresponding digit of the identification information, allowing the identification code to represent the identification information.

### CROSS REFERENCE TO RELATED APPLICATION

This application claims priority from U.S. Provisional Patent Application No. 62/713,892 filed on Aug. 2, 2018. The entire contents of the priority application are incorporated herein by reference.

### TECHNICAL FIELD

The technology described herein relates to an identification code for representing identification information in multiple digits.

### BACKGROUND ART

Japanese Unexamined Patent Application Publication No. 2000-123129 describes a character code including multiple dots on a loop path. At least one of the dots is different from the other dots. Such a character code requires less space than a barcode (one-dimensional code). Furthermore, a two-dimensional code, which has been recently developed, contains more information and requires less space than the conventional barcode (one-dimensional code).

For example, in a manufacturing process of a product, identification information such as a lot number is assigned to an object, such as a manufacturing unit, in some cases. The identification information may be required to be printed on the object. However, the object does not have a printable space large enough for the identification information in many cases. In such cases, the above-described two-dimensional code, for example, may be printed on the object. The identification number and the accompanying information is readable by using a reader. However, some objects are too small to have even the above-described character code or the two-dimensional code, for example. Furthermore, if an object has non-coded identification information, the identification information is readable with human eyes. However, if an object has the character code or the two-dimensional code, for example, the identification information is hardly readable with human eyes.

### SUMMARY

The technology described herein was made in view of the above-described circumstance. An object of the technology described herein is to provide an identification code that requires less space and is readable with human eyes.

An identification code for representing identification information in multiple digits According to the technology described herein includes dot position groups each including dot positions arranged in a circle, the dot position groups having different diameters and being concentrically arranged, the number of the dot position groups being the same as the number of digits of the identification information, dots representing positions selected from the dot positions in the dot position groups, a center mark at a center of the concentrically arranged dot position groups, and a reference mark located outwardly from the dot position groups and indicating a circumferential reference position, in which two of the dot position groups adjacent to each other in a radial direction are located such that a circumscribed circle of the dot positions in one of the dot position groups on an inner side and an inscribed circle of the dot positions in another of the dot position groups on an outer side overlap each other, and the dot positions in each of the dot position groups have different individual information pieces depending on where the dot positions are located relative to a line connecting the center mark with the reference mark, one of the dot positions in each of the dot position groups is selectively represented by one or more of the dots such that the individual information piece at the selected dot position represents information for the corresponding digit of the identification information, allowing the identification code to represent the identification information.

The technology described herein provides an identification code that requires less space and is readable with human eyes.

### BRIEF DESCRIPTION OF THE DRAWINGS

FIG. 1 is a plan view of a liquid crystal panel having an identification code according to a first embodiment.

FIG. 2 is a plan view illustrating the identification code of the first embodiment.

FIG. 3 is a plan view illustrating a modified identification code of the first embodiment.

FIG. 4 is a plan view of a liquid crystal panel having an identification code according to a second embodiment.

FIG. 5 is a plan view illustrating the identification code of the second embodiment.

FIG. 6 is a plan view illustrating a modified identification code of the second embodiment.

FIG. 7 is a plan view illustrating another modified identification code of the second embodiment.

### DETAILED DESCRIPTION

Some embodiments of the present technology are described in detail with reference to the drawings. However, the present technology is not limited to the embodiments described below. Various modifications and improvements may be made to the embodiments based on knowledge of those skilled in the art.

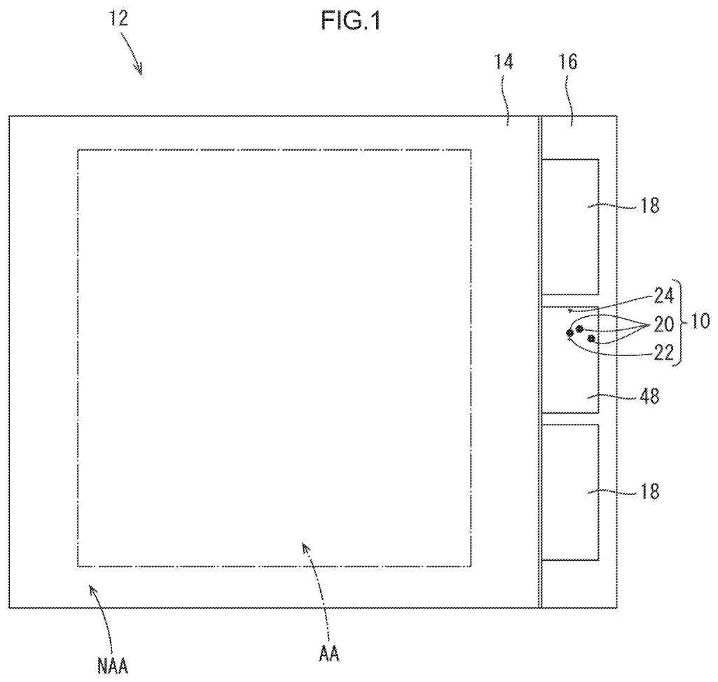

An identification code 10 according to a first embodiment is provided on a liquid crystal panel 12 illustrated in FIG. 1. The liquid crystal panel 12 is briefly described first. The liquid crystal panel 12, which is suitable for a small camera, has a substantially rectangular overall shape and has a relatively small size. The display surface of the liquid crystal panel 12 has a display area (active area) AA capable of displaying an image and a non-display area (non-active area) NAA incapable of displaying an image. The non-display area NAA has a frame-like shape and surrounds the display area AA. In FIG. 1, a one-dot chain line indicates an outline of the display area AA and the area outside the one-dot chain line is the non-display area NAA. The liquid crystal panel 12, which is suitable for a small camera, may have the display area AA in any shape such as a circular shape. The liquid crystal panel 12 includes two substrates 14 and 16 attached to each other. One of the substrates on the front side is a CF substrate 14 and one on the rear side is an array substrate 16. The CF substrate 14 and the array substrate 16 each include multiple films laminated on a substantially transparent glass substrate by photolithography, for example. A liquid crystal layer containing liquid crystal molecules, which are substances whose optical properties are changed by application of an electrical filed, is disposed between the substrates 14 and 16. As illustrated in FIG. 1, the array substrate 16 has a longer dimension in one direction than the CF substrate 14, and the array substrate 16 attached to the CF substrate 14 has a portion protruding from the CF substrate 14 to one side (to the right in FIG. 1). Electrodes 18 for supplying various signals are disposed on the portion of the array substrate 16 protruding from the CF substrate 14.

The liquid crystal panel 12 is expected to have printed identification information, such as lot information, which is individual identification information, to enable tracing of a manufacturing history. However, as described above, the liquid crystal panel 12, which is small, has a narrower frame width, and thus the non-display area NAA, which is an identification information printable area, is too narrow to have the identification information as it is.

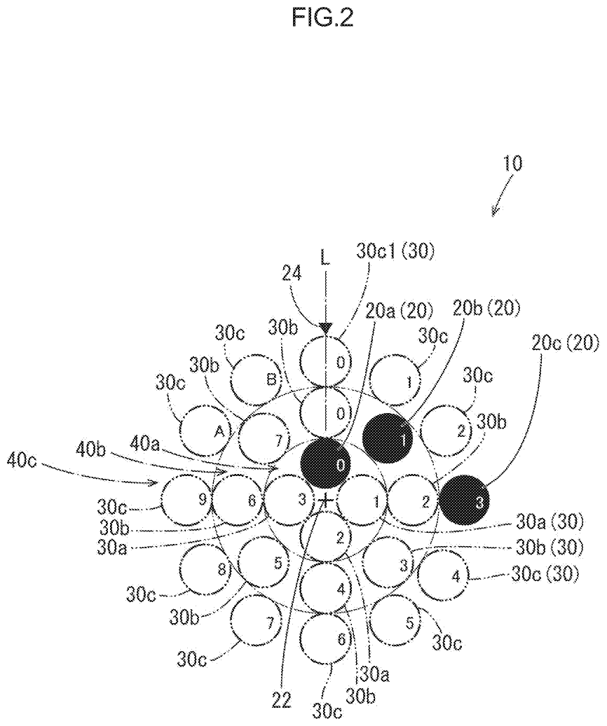

To solve the problem, a multiple-digit identification number (identification information) is assigned to the liquid crystal panel 12. The identification number is represented by an identification code 10, which is the first embodiment. As illustrated in FIG. 1, the identification code 10 includes three dots 20, a cross-shaped center mark 22, and a triangular reference mark 24. As illustrated in FIG. 2, the three dots 20 are selectively arranged at imaginary dot positions 30 indicated by two-dot chain lines. The center mark 22 and the reference mark 24 may be patterned when the thin films are formed in the process of producing the CF substrate 14 or the array substrate 16 of the liquid crystal panel 12, for example. Fine marks, such as the center mark 22 and the reference mark 24, are readily formed by patterning, reducing the area required by the identification code 10.

The identification code 10 includes three dot position groups 40a, 40b, and 40c each including the dot positions 30. The three dot position groups 40a, 40b, and 40c each include the dot positions 30 arranged in a circle. The dot position groups 40a, 40b, and 40c, which have different diameters, are concentrically arranged about the center mark 22. The innermost one of the dot position groups is the first dot position group 40a (hereinafter, may be simply referred to as a “a first group 40a”) and includes four dot positions 30a. The middle one of the dot position groups is the second dot position group 40b (hereinafter, may be referred to as a “second group 40b”) and includes eight dot positions 30b. The outermost one of the dot position groups is the third dot position 40c (hereinafter, may be referred to as a “third group 40c”) and includes twelve dot positions 30c. The reference mark 24 indicates a reference point in a circumferential direction of the circle centered at the center mark 22. The reference mark 24 is located outwardly from the third group 40c and points to a dot position 30c1 of the third group 40c. In this embodiment, the shape and the position of the reference mark are not limited to those described above. The reference mark may be located between the dot positions 30 adjacent to each other or may include multiple reference marks like scale marks as long as it can indicate the positions of the dot positions 30 in the circumferential direction.

The two dot position groups adjacent to each other, i.e., the first group 40a and the second group 40b and the second group 40b and the third group 40c, are in contact with each other. Specifically described, as illustrated in FIG. 2, the circumscribed circle of the four dot positions 30a of the first group 40a and the inscribed circle of the eight dot positions 30b of the second group 40b overlap each other, and the circumscribed circle of the eight dot positions 30b of the second group 40b and the inscribed circle of the twelve dot positions 30c of the third group 40c overlap each other.

In each of the dot position groups 40, the dot positions 30 in each of the groups have different individual information pieces depending on where the dot positions 30 are located relative to a reference line L, which connects the center mark 22 with the reference mark 24. Specifically described, in this embodiment, the numbers 0, 1, 2, 3 as the individual information pieces are respectively assigned to the dot positions in the first group 40a in a clockwise direction from the dot position on the reference line L, the numbers 0, 1, 2, 3, 4, 5, 6, and 7 are assigned to the dot positions in the second group 40b in a clockwise direction from the dot position on the reference line L, and the numbers 0, 1, 2, 3, 4, 5, 6, 7, 8, and 9, and the alphabets A and B are assigned to the dot positions in the third group 40c in a clockwise direction from the dot position on the reference line L.

The first, second, and third groups 40a, 40b, and 40c each have the dot 20 at only one of the dot positions 30. The dots 20 are provided on the completed liquid crystal panel 12. For example, the dots are provided by singeing or tarnishing a surface of a metal film 48, which has been formed on the array substrate 16 in advance for code printing, with a laser, for example.

In this embodiment, the dot position 30a corresponding to “0” is selected from the first group 40a and a dot 20a is positioned at the selected dot position 30a, the dot position 30b corresponding to “1” is selected from the second group 40b and a dot 20b is positioned at the selected dot position 30b, and the dot position 30c corresponding to “3” is selected from the third group 40c and a dot 20c is positioned at the selected dot position 30c. In the identification code 10, the individual information “0” represented by the first group 40a is the individual information piece for the first digit, the individual information “1” represented by the second group 40b is the individual information piece for the second digit, and the individual information “3” represented by the third group 40c is the individual information piece for the third digit. In other words, the number of dot position groups in the identification code 10 is the same as the number of digits, and the identification code 10 represents “013” as the identification number. The identification code 10 has a total of 384(=4×8×12) possible choices, because the first digit has four choices, the second digit has eight choices, and the third digit has twelve choices.

In the identification code 10 configured as above, the dot position group on an inner side and the dot position group on an outer side are in contact with each other. This allows the identification code 10 to have a relatively small size, enabling the liquid crystal panel 12, which has a relatively small size and a small printable area, to have the identification code 10. Furthermore, the identification code 10 is not only readable by using a dedicated reader but also readable by an operator, for example, who knows the individual information pieces assigned to the dot positions 30, without using a dedicated reader. The operator checks the positions of the three dots 20a, 20b, and 20c relative to the reference line L to read the identification number represented by the identification code 10.

In the identification code 10 of the embodiment, the dot positions 30 in the dot position groups 40 have the same size and the dot positions 30 in each of the dot position groups 40 are different in number. However, the present technology is not limited to this configuration. The dot positions 30 in the dot position groups 40 may have various sizes or the dot positions in each of the dot position groups may be the same in number. However, formation of the dots 20 is easy when the dot positions 30 in the dot position groups 40 have the same size as those in the present embodiment does, because a laser for forming the dots 20 only needs to change the position to form the dots 20.

In the identification code 10 of the embodiment, the digits represented by the dot position groups 40 are in descending order from the innermost dot position group 40. However, the digits may be in descending order from the outermost dot position group 40. The identification information may be represented by any combination of individual information pieces represented by the dot position groups 40. Furthermore, the number of dot position groups 40 may be two or four or more. The number is preferably small enough to allow easier reading with human eyes. In other words, the number is preferably two or more and four or less and is preferably three. Furthermore, in the identification code 10 of the embodiment, the number of dot positions 30c in the outermost third group 40c is twelve and the dot positions 30c are arranged in the same way as the numbers on the clock face. This allows the position of the dot 20c to be readily visually confirmed when an operator reads the identification code 10. Furthermore, the numbers “1” to “9” as individual information pieces are located at the positions of the same numbers on the clock face, allowing more easier reading with human eyes.

Although the identification code 10 of the embodiment has numbers and alphabets as the individual information pieces at the dot positions 30, hiragana, katakana, or symbols such as a circle, a triangle, and a square, for example, may be employed as the individual information pieces.

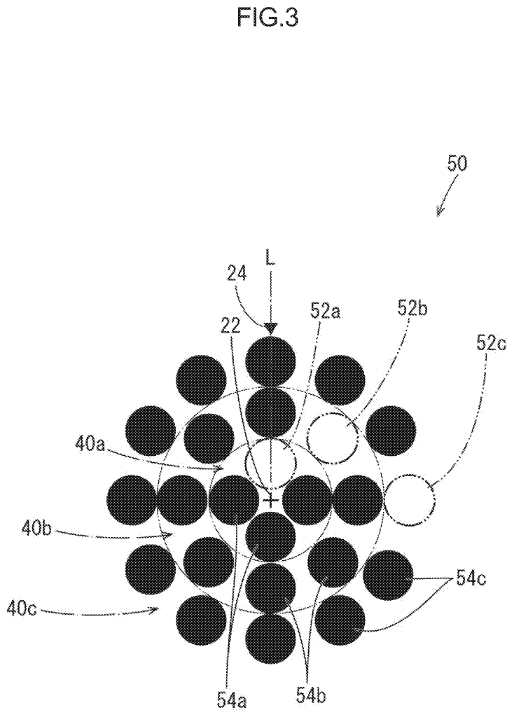

FIG. 3 illustrates an identification code 50, which is a modification of the first embodiment. The identification code 50 of the modification includes three dot position groups 40a, 40b, and 40c, the center mark 22, and the reference mark 24, as the identification code 10 of the first embodiment does. In the identification code 10 of the first embodiment, the dots 20 are arranged at the dot positions 30 having the individual information pieces such that each of the dots 20 represents the individual information piece for the corresponding digit of the identification number. In contrast, in the identification code 50 of the modification, dots 54a, 54b, and 54c are arranged at the dot positions in the dot position groups 40a, 40b, and 40c except dot positions 52a, 52b, and 52chaving the individual information pieces for the corresponding digits of the identification number. In other words, the identification code 10 of the first embodiment positively represents one of the dot positions in the dot position group 40 but the identification code 50 of the modification negatively represents the one. The identification code 50 of the modification represents the identification number “013”, which is the same number as that represented in the first embodiment.

The identification code 50 of the modification, which includes many dots 54a, 54b, and 54c, allows easy recognition of the arrangement positions relative to the reference line L with human eyes. The identification number is readily readable.

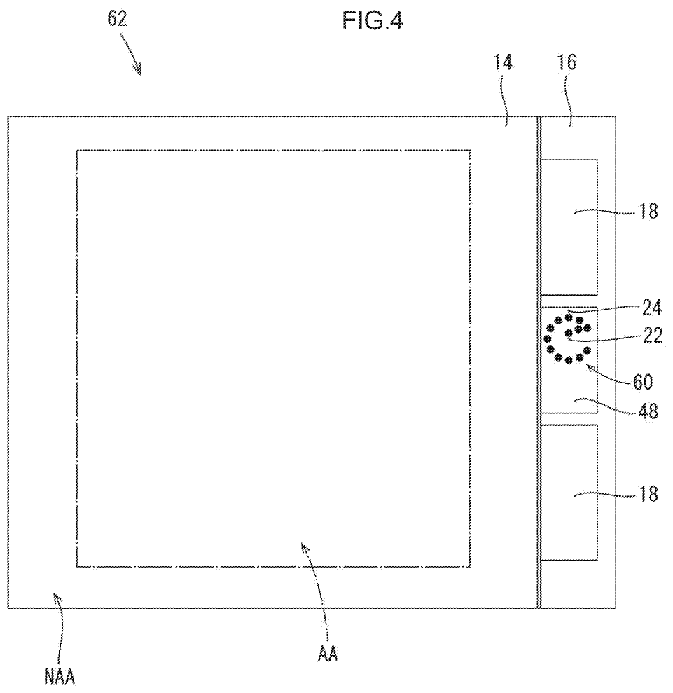

FIG. 4 illustrates a liquid crystal panel 62 having an identification code 60 of a second embodiment. The liquid crystal panel 62 has the same configuration as the liquid crystal panel 12 of the first embodiment, and the components thereof are not described. Furthermore, the identification code 60 of the second embodiment includes three dot position groups 40a, 40b, and 40c, the center mark 22, and the reference mark 24, as the identification code 10 of the first embodiment does. The first embodiment represents the identification number in either a positive way or a negative way. However, the identification code 60 of the second embodiment represents the identification number in both positive and negative ways. The identification number represented by the identification code 60 of the second embodiment is “013”, which is the same number as that represented in the first embodiment.

The identification code 60 of the second embodiment negatively represents one of the dot positions that has the individual information piece of the identification number in the third group 40c, which is the outermost dot position group, and positively represents one of the dot positions that has the individual information piece of the identification number in each of the first group 40a and the second group 40b, which are the dot position groups on the inner side. Specifically described, in the third group 40c, dots 72 are arranged at all the dot positions except the dot position 70c to represent the individual information piece for the third digit of the identification number. In contrast, dot 74a is arranged at only one of the dot positions in the first group 40a to represent the individual information piece for the first digit of the identification number, and a dot 74b is arranged at only one of the dot positions in the second group 40b to represent the individual information piece for the second digit of the identification number.

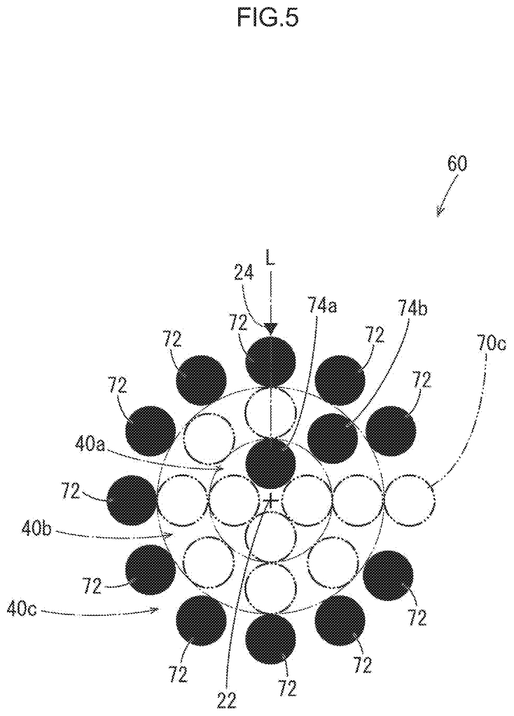

As illustrated in FIG. 5, the identification code 60 of the second embodiment negatively represents the individual information piece of the identification number in the outermost third dot position group 40c, where the number of dot positions is largest. This allows the individual information piece represented by the third group 40c to be readily visually recognizable. Furthermore, the position of the dot 74a in the first group 40a and the position of the dot 74b in the second group 40b, which are positively represented, are readily visually recognized when contrasted with the dots 72 in the third group 40c. Thus, the identification code 60 of the second embodiment is more readily readable with human eyes than the identification code 10 of the first embodiment, which represents the identification number only in a positive way. Furthermore, the identification code 60 of the second embodiment represents the identification number by using a smaller number of dots than the identification code 50 of the modification of the first embodiment, which represents the identification number only in a negative way. This reduces the time taken to provide the identification code on an object.

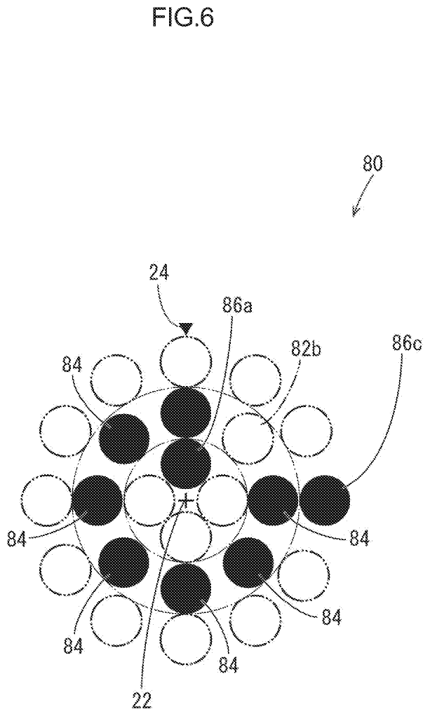

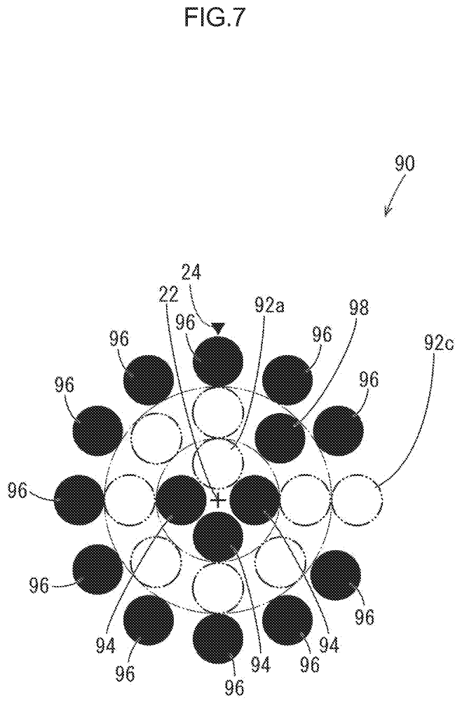

FIG. 6 illustrates an identification code 80, which is a modification of the second embodiment, and FIG. 7 illustrates an identification code 90, which is another modification. The identification codes 80 and 90 of the modifications each include three dot position groups 40a, 40b, and 40c, the center mark 22, and the reference mark 24, as the identification code 60 of the second embodiment does. The identification codes 80 and 90 of the modifications each represent the identification number in both positive and negative ways as the identification code 60 of the second embodiment does and each alternately include the dot position group positively representing the individual information piece of the identification number and the dot position group negatively representing the individual information piece of the identification number.

In other words, in the identification code 80 in FIG. 6, the first and third groups 40a and 40c each positively represent the individual information piece of the identification number and the second group 40b negatively represents the individual information piece of the identification number. Specifically described, dots 84 are arranged at all the dot positions except a dot position 82b in the second group 40b such that the individual information piece for the second digit of the identification number is represented by the dot position 82b. In contrast, a dot 86a is arranged at only one of the dot positions in the first group 40a to represent the individual information piece for the first digit of the identification number, and dot 86c is arranged at only one of the dot positions in the third group 40c to represent the individual information piece for the third digit of the identification number.

In contrast, the identification code 90 illustrated in FIG. 7 negatively represents the individual information pieces of the identification number in the first and third groups 40a and 40c and positively represents the individual information piece of the identification number in the second group 40b. Specifically described, dots 94 are arranged at all the dot positions except a dot position 92a in the first group 40a such that the individual information piece for the first digit of the identification number represented by the dot position 92a. Furthermore, dots 96 are arranged at all the dot positions except a dot, position 92c in the third group 40c such that the individual information. piece for the third digit of the identification number is represented by the dot position 92c. In contrast, a dot 98 is arranged at only one of the dot positions in the second group 40b to represent the individual information piece for the second digit of the identification number.

In each of the identification codes 80 and 90 of the modifications, the individual information pieces of the identification number are represented alternately in a negative way and a positive way, and thus the negatively represented individual information piece is readily readable with human eves. Furthermore, such a configuration allows the positively represented dot position to he readily readable with human eyes when contrasted with the dots in the negatively representing dot position group. The identification code alternately including the negatively representing dot position group and the positively representing dot position group is advantageous for a configuration including four or more dot position groups.

1. An identification code for representing identification information in multiple digits, comprising:
dot position groups each including dot positions arranged in a circle, the dot position groups having different diameters and being concentrically arranged, the number of the dot position groups being the same as the number of digits of the identification information;
dots representing positions selected from the dot positions in the dot position groups;
a center mark at a center of the concentrically arranged dot position groups; and
a reference mark located outwardly from the dot position groups and indicating a circumferential reference position, wherein
two of the dot position groups adjacent to each other in a radial direction are located such that a circumscribed circle of the dot positions in one of the dot position groups on an inner side and an inscribed circle of the dot positions in another of the dot position groups on an outer side overlap each other, and
the dot positions in each of the dot position groups have different individual information pieces depending on where the dot positions are located relative to a line connecting the center mark with the reference mark, one of the dot positions in each of the dot position groups is selectively represented by one or more of the dots such that the individual information piece at the selected dot position. represents information for the corresponding digit of the identification information, allowing the identification code to represent the identification information.

2. The identification code according to claim 1, wherein the dot position groups each have the dot at the selected one of the dot positions to represent the selected dot position.

3. The identification code according to claim 1, wherein the dot position groups each have the dots at all the dot positions except a selected one of the dot positions to represent the selected dot position.

4. The identification code according to claim 1, wherein one of the dot position groups has the dots at all the dot positions except a selected one of the dot positions to represent the selected dot position, and
another of the dot position groups has the dot at a selected one of the dot positions to represent the selected dot position.

5. The identification code according to claim 1, wherein the dot position groups alternately include a dot position group including the dots at all the dot positions except a selected one of the dot positions to represent the selected dot position and a dot position group including the dot at a selected one of the dot positions to represent the selected dot position.

6. The identification code according to claim 1, wherein the number of the dot positions in as outermost one of the dot position groups is twelve.

7. The identification code according to claim 1, wherein the identification information is assigned to a liquid crystal panel, and the identification code is provided on the liquid crystal panel.
